(19) United States
(12) Patent Application Publication
(10) Pub. No.: US 2017/0018986 A1
(43) Pub. Date: Jan. 19, 2017

(54) GENERATOR ASSEMBLY WITH COVER PLATES

(71) Applicant: HeliosAltas Corp., Roseville, CA (US)

(72) Inventors: Phillip Chauvin, Lincoln, CA (US); Michael Thomas Carroll, Roseville, CA (US)

(21) Appl. No.: 15/209,235

(22) Filed: Jul. 13, 2016

Related U.S. Application Data
(60) Provisional application No. 62/192,210, filed on Jul. 14, 2015.

(51) Int. Cl. H02K 5/10

(52) U.S. Cl. CPC H02K 5/10

(57) ABSTRACT

The present invention relates to a generator assembly with cover plates. The present invention includes a housing with a sidewall and end walls. The end walls have a central opening and a drive shaft extends through the central opening of the end walls. A pair of cover plates are mounted on the drive shaft at each end and are positioned on the outside of the housing with the cover plates overlapping the end walls, which forms a shell. The shell has a hollow interior. A generator is also mounted on the drive shaft and is positioned within the hollow chamber formed by the shell.

### CROSS-REFERENCE TO RELATED APPLICATIONS

This application claims priority to Provisional Application U.S. Ser. No. 62/192,210 filed on Jul. 14, 2015, of which is herein incorporated by reference in its entirety.

### BACKGROUND OF THE INVENTION

This invention is directed to a generator assembly and more particularly to a generator assembly having cover plates.

The need for renewable energy or green energy is ever growing as climate change continues to impact the planet. According to the United States Geological Survey, as of 2014, hydroelectric energy constitutes the largest portion of the renewable energy consumed by the United States. Even so, the adoption of renewable energy only encompasses about 10% of the United States energy consumption. One of the biggest issues that hinders the adoptions of renewable energy is cost.

Presently many unpowered water wheels exist that use the power of flowing water to complete various tasks. Despite generator assemblies being well-known in the art, the process to convert these water wheels to produce electricity is expensive, complex, and time consuming. Thus it is a primary objective of this invention to provide a generator assembly with cover plates that improves upon the art.

Another objective of this invention is to provide a generator assembly with cover plates that is capable of being easily fitted to an unpowered water wheel to produce electricity.

Yet another objective of this invention is to provide a generator assembly with cover plates that can be universally mounted.

Another objective of this invention is to provide generator assembly with cover plates that is cost effective.

These and other objectives, features, and advantages of the invention will become apparent from the specification and claims.

### BRIEF DESCRIPTION OF THE DRAWINGS

FIG. 1 is a side view of a generator assembly with cover plates;

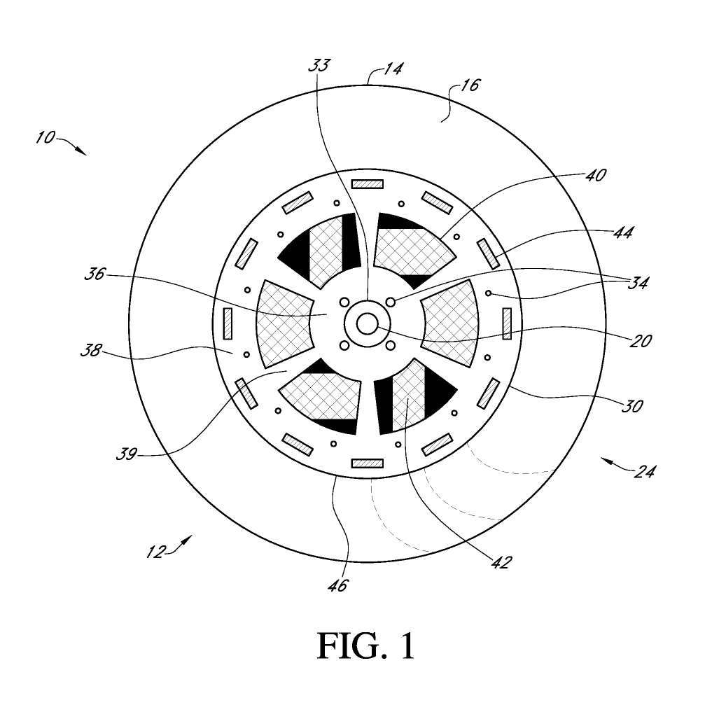

FIG. 2 is a side view of a cover for a generator assembly with cover plates;

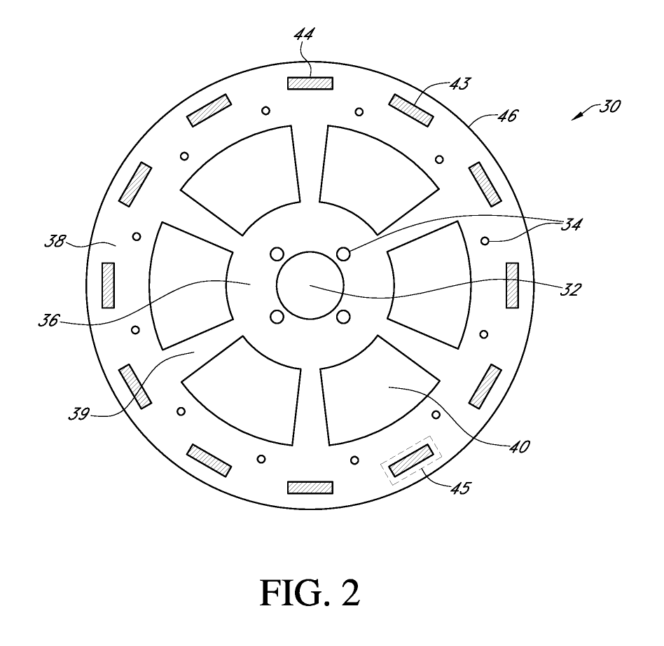

FIG. 3 is a front cross-sectional view of a generator assembly with cover plates; and

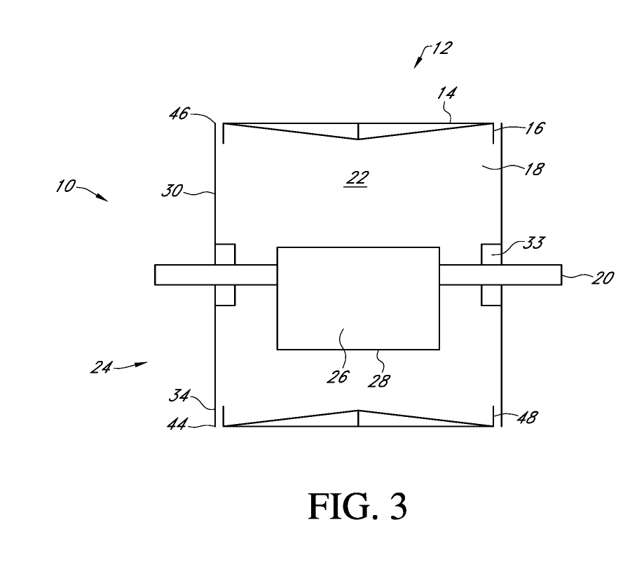

FIG. 4 is a front cross-sectional view of a generator assembly with cover plates.

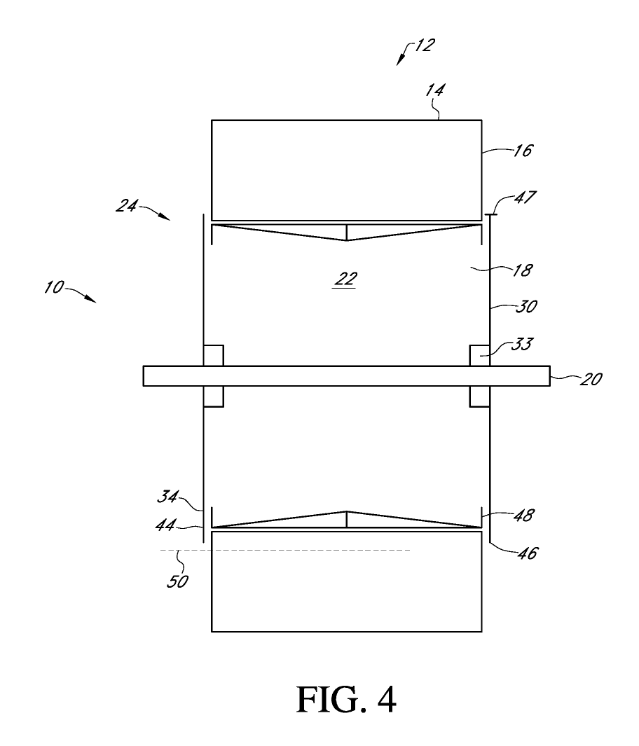

### SUMMARY OF THE INVENTION

A generator assembly with cover plates includes a housing with a sidewall and end walls. The end walls have a central opening and a drive shaft that extends through the central opening of the end walls. A pair of cover plates are mounted on the drive shaft at each end and are positioned on the outside of the housing with the cover plates overlapping the end walls. The cover plates positioning over the opening of the housing forms a shell having a hollow interior. A generator is also mounted on the drive shaft and is positioned within the hollow chamber formed by the shell.

The cover plates include one or more weep holes, one or more bolts, and one or more vents. The cover plates are aligned in such a manner with an internal ridge of the housing that during operation water is displaced through the weep holes.

The present invention allows pre-existing, or new, water wheels to be modernized for use in producing renewable energy in a cost-effective manner. By adapting or replacing the drive shaft of pre-existing water wheels, mounting a generator, and mounting one or more cover plates, the present invention provides energy to be generated from flowing water in a cost-effective, simple, and efficient manner.

### DETAILED DESCRIPTION OF THE PREFERRED EMBODIMENTS

Referring to the Figures, a water generator assembly 10 has a housing 12 having a sidewall 14 and a pair of end walls 16. The end walls 16 extend inwardly from each end of the sidewall 14. In another arrangement, a single end wall 16 extends inwardly, for example an elongated body that extends across the length of the side wall 14. In other arrangements, the one or more end walls 16 extend radially inward in an O-shape. In one arrangement, the sidewall 14 is continuous and round. In one embodiment, the housing 12 is a pre-existing water wheel.

The end walls 16 have a central opening 18 through which a drive shaft 20 extends. The drive shaft 20 has a pair of cover plates 30 mounted to each end of the shaft 20. The cover plates 30 are positioned such that the cover plates 30 and end walls 16 form a shell 24 having a hollow chamber 22. Mounted to the drive shaft 20 within the shell 24 is a generator 26 having a generator housing 28.

The cover plates 30 have a central opening 32 through which the drive shaft 20 extends. The drive shaft 20, in one arrangement, is attached to a bearing flange 33 that is positioned within central opening 32 that facilitates rotation. The cover plates 30 are attached to the generator 26 with a plurality of bolts 34 positioned around the central opening 32 on an inner ring 36 and around an outer ring 38 of the cover plates 30. Between the inner ring 36 and the outer ring 38 of the cover plates 30 are a plurality of vents 40. In this arrangement, a plurality of spokes 39 extend between the inner ring 36 and the outer ring 38 in the areas not occupied by the plurality of vents 40. In one embodiment of the present invention, the plurality of vents 40 are covered with a breathable material or reinforced breathable material 42 such as a screen or the like to allow air circulation.

Radially positioned on the outer ring 38 of the cover plates 30 are a plurality of weep holes 44. The weep holes 44 are positioned between the bolts 34 and a cover edge 46 of the cover plates 30 so that the bolts 34 do not affect the water inside of the shell 24 during operation. The weep holes 44 are of any size and shape and may include a rim or a lip 43 to prevent water from entering during operation. In one example, the cover edge 46 has a rim or lip 47 that prevents water on the top of the housing 12 from interfering with the plurality of vents 42 and weep holes 44 as it runs down the shell 24. Also, in one embodiment, check valves 45 are installed in the weep holes 44 to allow flow in one direction. Preferably, the cover plates 30 are symmetrical with each other so that a cord 49 (not shown) that is in communication with the generator 26 may exit on either end depending on where the water generator assembly 10 is positioned in a stream or canal thereby facilitating the retrieval of power from the water generator assembly 10.

In operation, the generator 26 is mounted on the drive shaft 20 extending through the central opening 18 of the housing 12. The cover plates 30 are then mounted on opposing sides of the drive shaft 20 and positioned such that the cover plates 30 overlap at least a portion of the end walls 16 of the housing 12. In one arrangement, the outside ring 38 of the cover plates 30 is positioned to meet an internal ridge 48 of each end wall 16 of the housing 12. In one particular arrangement, the outside ring 38 is positioned such that the internal ridge 38 and the weep holes 44 align or meet.

Also, in one exemplary embodiment, the cover edge 46 of the cover plates 30 is positioned so that the lowest point of the cover plates 30 is above the highest point of the water level 50. In this arrangement, water is prevented from entering the weep holes 44.

During operation, water flow will cause the shell 24 to rotate with centrifugal force. The centrifugal force of the shell 24 pushes water to the outside of the shell 24. The internal ridge 48 forces the water towards the cover plates 30. When the cover plates 30 are positioned so that the weep holes 44 and internal ridge 48 align, the water is pushed directly through weep holes 44, which optimizes operation.

The generator assembly 10 is adaptable to existing the housing 12 of unpowered water wheels as the drive shaft 20 of existing water wheels may be replaced with the generator assembly 10. The bolt 34 pattern of the generator assembly 10 matches existing drive shafts 20 making replacement simple and easy. Also, a second mounting includes a cylinder with a shaft of power equipment disposed inside the cylinder that is mounted to an existing water wheel.

Therefore, a water generator assembly 10 has been provided that is capable of being easily fitted to an unpowered water wheel to produce electricity, that can be universally mounted, that is cost effective, and improves upon the art.

From the above discussion and accompanying figures and claims it will be appreciated that the water generator assembly 10 offers many advantages over the prior art. It will be appreciated further by those skilled in the art that other various modification could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A generator assembly comprising:
a housing having a sidewall and a pair of end walls;
the end walls having a central opening;
a drive shaft extending through the central opening;
a pair of cover plates mounted on the drive shaft and positioned on the exterior of the housing with a portion of the cover plates overlapping with the end walls to form a shell having a hollow interior; and
a generator mounted on the drive shaft and within the hollow chamber.

2. The generator assembly of claim 1 further comprising at least one cover plate positioned such that an outer ring of the cover plate aligns with an internal ridge of the end wall.

3. The generator assembly of claim 1 further comprising at least one cover plate having at least one weep hole, wherein the at least one cover plate is positioned such that the weep hole aligns with an internal ridge of the end wall.

4. The generator assembly of claim 1 further comprising the cover plates have a cover edge, wherein the cover edge of the cover plates is positioned above the water level.

5. The generator assembly of claim 1 further comprising a rim along a cover edge of the cover plates.

6. The generator assembly of claim 1 further comprising the cover plates having one or more weep holes.

7. The generator assembly of claim 6 wherein the cover plates are positioned between a cover edge and one or more bolts on an outer ring of the cover plates.

8. The generator of claim 1 further comprising the cover plates having an inner and an outer ring.

9. The generator of claim 8 further comprising at least one vent positioned between the inner rings and outer rings.

10. The generator of claim 9 further comprising a breathable material covering the at least one vent.

11. A generator assembly comprising:
a housing having a sidewall and a pair of end walls;
the end wall having a central opening;
a drive shaft extending through the central opening;
at least one cover plate mounted on the drive shaft and positioned on the exterior of the housing with a portion of the cover plate overlapping with one of the end walls; and
a generator mounted on the drive shaft and within housing.
